(19) United States
(12) Patent Application Publication
(10) Pub. No.: US 2010/0078848 A1
(43) Pub. Date: Apr. 1, 2010

(54) SPINNERET AND METHOD OF SPINNING FIBER

(75) Inventors: Peter D. GABRIELE, York, PA (US); Jeffrey H. ROBERTSON, York, PA (US); Jeffrey S. HAGGARD, Cocoa, FL (US)

Correspondence Address: MCNEES WALLACE & NURICK LLC, 100 PINE STREET, P.O. BOX 1166, HARRISBURG, PA, 17108-1166, US

(73) Assignees: ARMARK AUTHENTICATION TECHNOLOGIES, LLC, Glen Rock, PA (US); HILLS INC., West Melbourne, FL (US)

(21) Appl. No.: 12/568,387

(22) Filed: Sep. 28, 2009

Related U.S. Application Data
(60) Provisional application No. 61/100,880, filed on Sep. 29, 2008.

(51) Int. Cl. B29C 47/08; B29C 47/06; D01D 5/30

(52) U.S. Cl. 264/172.15; 425/131.5; 264/172.17

(57) ABSTRACT

Disclosed is a spinneret and a method of spinning. The spinneret includes a first pore configured for extruding a first component of a multi-component fiber, a second pore configured for extruding a second component of the multi-component fiber, and a thermal insulator positioned between the first pore and the second pore and configured for preventing heat from the first component from damaging the second component. The first component and the second component have incompatible thermal resistance.

### FIELD

The present disclosure generally relates to a spinneret and a method of spinning fiber. In particular, the present disclosure relates to a spinneret having a thermal insulator preventing damage to components of multi-component fibers.

### BACKGROUND

A co-extrusion process can be used in manufacturing various bi-component fibers and other multi-component fibers. The co-extrusion process can include forcing a viscous precursor fluid through a pore to form a continuous filament. The continuous filament can be partially solid and partially liquid. The continuous filament can be thermoplastic thereby softening when heated or can be dissolvable when contacted with a suitable solvent. The precursor fluid can be converted into a rubbery state and then solidified into the fiber. Upon forcing two precursor fluids through the pores, the fiber can be arranged as a multi-component fiber.

A spinneret can include one pore, several hundred pores, or any number of pores. The fiber emerges from the pores in the spinneret. Spinnerets are used to manufacture fibers by wet spinning, dry spinning, melt spinning, and/or gel spinning Wet spinning involves a precursor fluid dissolved in a solvent to form a fiber by submerging a spinneret in a chemical bath and forcing the precursor through the pores as the filament emerges into a solution wherein it solidifies to form the fiber. Dry spinning involves a precursor fluid dissolved in a solvent to form a filament by precipitating the precursor fluid by dilution or chemical reaction, then solidifying it by evaporating the solvent in a stream of air or inert gas.

Melt spinning involves a melted precursor fluid being forced through the pores of a spinneret and solidified by cooling to form the fiber. Melt spinning can involve additional cross-sectional shapes (round, trilobal, pentagonal, octagonal, and others). Gel spinning involves the precursor fluid being a polymer chain bound together at various points in liquid crystal form by forcing the precursor fluid through the pores of a spinneret, contacting the precursor fluid with air, and then cooling the precursor fluid in a liquid bath to form the fiber.

Wet spinning, dry spinning, melt spinning, and gel spinning can suffer from drawbacks. When forming multi-component fibers having components of varying thermal compatibility according to any of these techniques, the selection of a processing temperature can damage one or more of the components. For example, a first component can require a temperature (for example, about 200° F. (93° C.)) to have a desired viscosity. A second component can include biological substances denatured by exposure to that temperature or even a lower temperature (for example, 150° F. (66° C.)). Exposing the precursor to the higher temperature can, thus, denature the biological substances when forming the fiber. Problems relating to incompatibility among desired components can limit options that might otherwise be desirable, thus reducing the applicability of co-extrusion processes.

What is needed is a spinneret and a method of spinning capable of forming multi-component fibers from thermally incompatible components.

### SUMMARY

An aspect of the present disclosure includes a spinneret including a first pore configured for extruding a first component of a multi-component fiber, a second pore configured for extruding a second component of the multi-component fiber, and a thermal insulator positioned between the first pore and the second pore and configured for preventing heat from the first component from damaging the second component. In the embodiment, the first component and the second component have incompatible thermal resistance.

Another aspect of the present disclosure includes a spinneret including a first pore configured for extruding a high-temperature component of a multi-component fiber, a second pore configured for extruding a low-temperature component of the multi-component fiber, and a thermal insulator positioned between the first pore and the second pore. The thermal insulator includes a substrate having one or more cavities defined by the substrate, the one or more cavities being configured for receiving an insulating substance. In the embodiment, the thermal insulator is configured for transferring a lesser amount of heat from the first pore and a greater amount of heat from the second pore, thereby preventing heat from the high-temperature component from damaging the low-temperature component and for transferring heat from the one or more cavities. Also, the high-temperature component and the low-temperature component have incompatible thermal resistance.

Another aspect of the present disclosure includes a spinning process including providing a spinneret, introducing the first component of the multi-component fiber to the spinneret, introducing the second component of the multi-component fiber to the spinneret, extruding the first component through the first pore of the spinneret, extruding the second component through the second pore of the spinneret, transferring a lesser amount of heat form the first pore, the first component being a high-temperature component, transferring a greater amount of heat from the second pore, the second component being a low-temperature component, and forming the multi-component fiber. In the embodiment, the spinneret includes a first pore configured for extruding a first component of a multi-component fiber, a second pore configured for extruding a second component of the multi-component fiber, and a thermal insulator positioned between the first pore and the second pore and configured for preventing heat from the first component from damaging the second component. Also, the first component and the second component have incompatible thermal resistance.

One advantage of the present disclosure includes thermally insulating temperature sensitive components from high temperatures desirable for other components during fiber spinning

Another advantage of the present disclosure includes permitting combination of otherwise incompatible components.

Another advantage of the present disclosure includes additional control of processing multi-component fibers.

Other features and advantages of the present disclosure will be apparent from the following more detailed description of the preferred embodiments, taken in conjunction with the accompanying drawings which illustrate, by way of example, the principles of the disclosure.

### BRIEF DESCRIPTION OF THE DRAWINGS

FIG. 1 is a schematic representation of an exemplary embodiment of a spinneret in a spinning system.

FIG. 2 is a cross-section view of an exemplary embodiment of a spinneret.

FIG. 3 is a cross-section view of a multi-component fiber formed by the exemplary spinneret of FIG. 2.

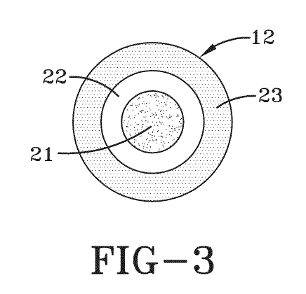

Wherever possible, the same reference numbers will be used throughout the drawings to represent the same parts.

### DETAILED DESCRIPTION

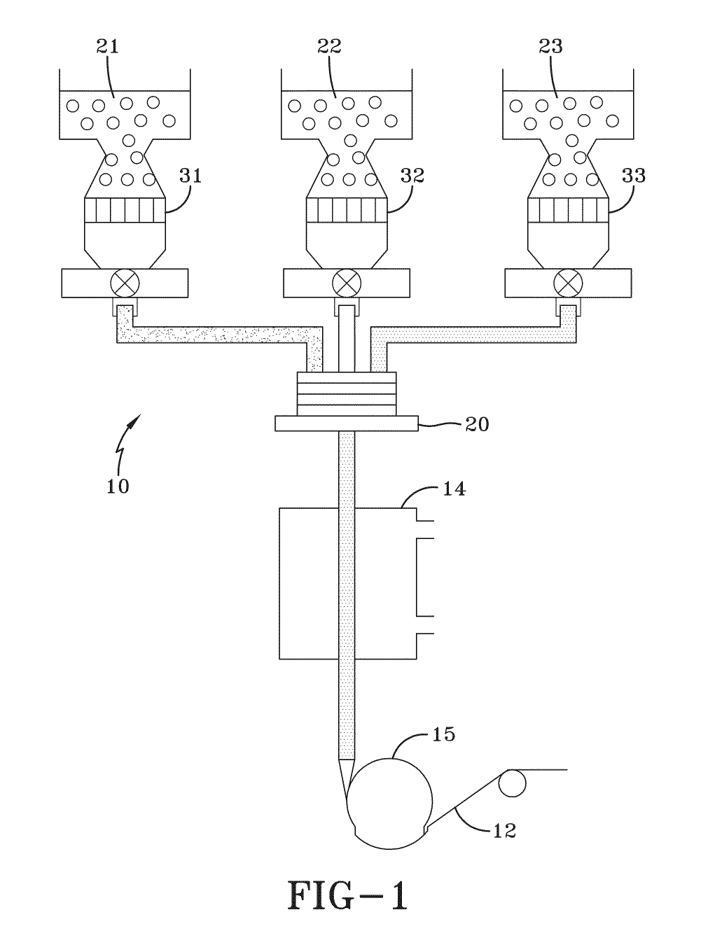

Provided is a spinning system and method of spinning capable of forming a multi-component fiber from incompatible components. Referring to FIG. 1, a spinning system 10 may be used to extrude incompatible components having incompatible thermal resistance and may substantially continuously produce a multi-component fiber 12. The spinning system 10 can be configured for wet spinning, dry spinning, melt spinning, gel spinning, other suitable spinning processes, or combinations thereof. The spinning system 10 includes a plurality of extruders 31, 32, 33, a spinneret 20, a solidifier 14, a roll 15, and other suitable processing equipment. The solidifier 14 can be any suitable device and/or region for solidifying components extruded by the spinneret 20. For example, in wet spinning, solidifier 14 may be a chamber including a solution for solidifying fiber 12. In dry spinning, for example, solidifier 14 may be a region exposed to a stream of air or inert gas. In melt spinning, the solidifier 14 may be a cooling chamber by way of example only. In gel spinning, the solidifier 14 may be a stream of air or inert gas, a cooling chamber, and/or a liquid bath, again by way of example. The roll 15 can be any mechanism for collecting, orienting, and/or arranging the fiber 12.

The extruders 31, 32, 33 generally provide a substantially continuous flow of component fluid to the spinneret 20. The extruders 31, 32, 33 may individually provide incompatible components and/or compatibilizing components to be combined in the spinneret 20. Two or more incompatible components may be provided. In addition, compatibilizing components may optionally be provided. Compatibilizing components may act as a barrier between incompatible components. In one embodiment, the compatibilizing components may be formed from an insulating component 22 introduced to the spinneret 20. Incompatible components and/or compatibilizing components can be extruded through the spinneret 20 and solidified while passing through the solidifier 14. Incompatible components and/or compatibilizing components can then be oriented by the roll 15 and may be provided to further processing stages (not shown) in accordance with known fiber processing techniques, such as winding, cutting, etc. In one embodiment, incompatible components may include a low-temperature component 21 and a high-temperature component 23 provided to the spinneret 20, in which the low-temperature component 21 refers to a component with a desired processing temperature lower than the high-temperature component 23 and the high-temperature component 23 refers to a second component with a desired processing temperature greater than the low-temperature component 21. The low-temperature component 21 and the high-temperature component 23 have incompatible thermal resistance with one another.

The spinneret 20 can receive fluid from the first extruder 31, the second extruder 32, and/or the third extruder 33. The fluid from the first extruder 31 can include the low-temperature component 21. The fluid from the second extruder 32 can include the insulating component 22. The fluid from the third extruder 33 can include the high-temperature component 23. The fluids can remain separate prior to being introduced to the spinneret 20. In one embodiment, the low-temperature component 21 may be susceptible to damage when the temperature reaches a predetermined point. For example, if the low-temperature component 21 is (or includes) a bio-molecule, it may denature when the temperature reaches a range of about 106° F. (41° C.) to about 112° F. (44° C.). As used herein, the term “bio-molecule” refers to materials derived from living things (for example, cellulose, fragrances, material derived from corn, etc.). Generally bio-molecules have relatively low temperature tolerance. In another embodiment, it may be desirable for the high-temperature component 23 to be processed at a higher temperature. For example, if the high-temperature component 23 is a viscous polymer, it may be desirable for the high-temperature component 23 to be processed at a temperature permitting quicker flow of the viscous polymer. Various ranges of temperatures for the low-temperature component 21, the insulating component 22, and/or the high-temperature component 23 may also be desirable. The temperature ranges may vary depending upon the heat conductivity and the thickness of insulating component 22, depending upon the temperature tolerances of the low-temperature component 21, and other suitable factors. In one embodiment, a range in temperature between the low-temperature component 21 and the high-temperature component 23 may be about 100 degrees C. Additionally or alternatively, the volume/area, arrangement, and/or amount of the components 21, 22, 23 may be controlled based upon the fluid from the extruders 31, 32, 33, the arrangement and/or manipulation of the spinneret 20, and/or other suitable process controls.

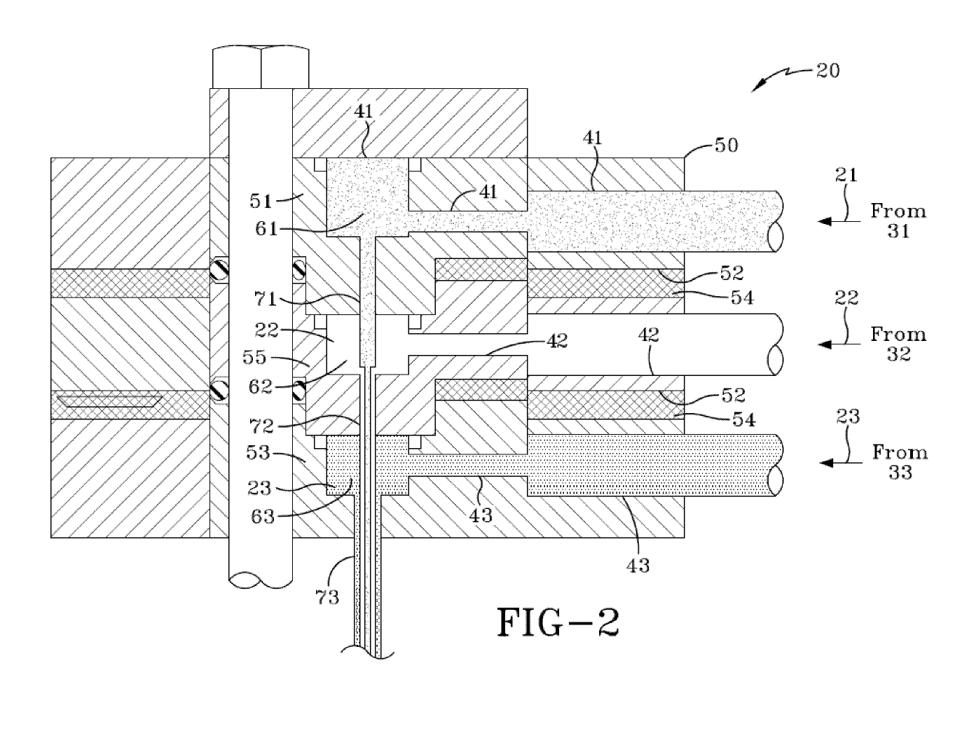

Referring to FIG. 2, the spinneret 20 can include a fluid channel 41 configured to receive the low-temperature component 21 introduced from the first extruder 31. The spinneret 20 can include a second fluid channel 42 configured to receive the insulating component 22 introduced from the second extruder 32. Also, the spinneret 20 can include a third fluid channel 43 configured to receive the high-temperature component 23 introduced from the third extruder 33. Fluid channels 41, 42, 43 can be defined by a thermal insulator 50.

The thermal insulator 50 can include cavities 52 arranged and disposed between the first fluid channel 41 and the second fluid channel 42 and/or cavities 52 arranged and disposed between the second fluid channel 42 and the third fluid channel 43. The cavities 52 can be filled with an insulating substance 54 to aid thermal separation among the components 21, 22, 23. The insulating substance 54 can be any suitable high insulating material. In one embodiment, the insulating substance 54 may be a transport fluid or a suitable refrigerant for transferring heat away from one or more of the cavities 52. In another embodiment, the insulating substance 54 may be air. The second fluid channel 42 may be arranged and disposed between the first fluid channel 41 and the third fluid channel 43 to provide additional thermal separation of the high-temperature component 23 and the low-temperature component 21.

The thermal insulator 50 can be composed of a low heat-conducting metal or another suitable durable substance having insulating properties. The thermal insulator 50 can include a first substrate 51 including a first pore 61, a second substrate 55 including a second pore 62, and a third substrate 53 including a third pore 63. Substrates 51, 55, and 53 may stacked. The fluid channel 41 can introduce the low-temperature component 21 to the first pore 61. The second fluid channel 42 can introduce the insulating component 22 to second pore 62. The third fluid channel 43 can introduce the high-temperature component 23 to the third pore 63. Thus, each of the pores 61, 62, 63 can be configured for use under different thermal conditions. Configuration of the pores 61, 62, 63 can be modified by adjusting the shape, size, arrangement, or other suitable property of the pores 61, 62, 63. The first pore 61 can be configured for relatively low heat (for example, by having a larger pore and/or being surrounded by the insulating substance 54). The second pore 62 can be configured for insulating (for example, by being made of the insulating substance 54 and/or other suitable insulating materials). The third pore 63 can be configured for relatively high heat (for example, by having a smaller pore and/or substrate being lower in volume). The configuration for thermal conditions of the pores 61, 62, 63 can be adjusted as desired. For example, a fiber with a fluid interior may be formed by configuring the first pore 61 for high heat, for example, by adjusting the flow rate of the insulating substance 54 flowing through the cavities 52 and thereby adjusting the amount of heat transferred, configuring the second pore 62 for moderate heat, and configuring the third pore 63 for low heat. Other suitable combinations of configuring the pores 61, 62, 63 for differing thermal conditions and/or equal thermal conditions may also be utilized. In one embodiment, more than three pores may be utilized.

The spinneret 20 can include the first pore 61, the second pore 62, and the third pore 63 arranged and disposed for extrusion of the multi-component fiber 12. The pores 61, 62, 63 can be any desired shape and size aperture, slot, series of slots, or other suitable feature permitting controlled extrusion of each component of the multi-component fiber 12. The first pore 61 can receive the low-temperature component 21 from the first fluid channel 41. The first pore 61 can then be used to extrude a first filament stream 71 through and into the second pore 62. The second pore 62 can receive the insulating component 22 from the second fluid channel 42. The second pore 62 can be used to extrude a second filament stream 72. The second filament stream 72 can be coaxial in relation to the first filament stream 71. Additionally or alternatively, the second filament stream 72 may be intertwined or spiraled around the first filament stream 71. The second filament stream 72 may be a bi-component filament stream and may include a sheath/core configuration in which the core is formed of the low-temperature component 21 (for example, a temperature sensitive active pharmaceutical ingredient) and the sheath is formed of the insulating component 22, such as polypropylene, polyethylene, and/or other suitable materials with low thermal conductivity, low melt temperature, and high heat tolerance. The sheath may serve to insulate the core during processing of the bi-component filament stream within the third pore 63, where the bi-component filament stream may be introduced to the high-temperature component 23.

Upon being extruded by the second pore 62, the second filament stream 72 can be introduced to the third pore 63. The third pore 63 can receive the high-temperature component 23 from the second fluid channel 42. The third pore 63 can then extrude the third filament stream 73. The third filament stream 73 can be arranged coaxial in relation to the first filament stream 71 and/or the second filament stream 72, intertwined or spiraled around one or more of the first filament stream 71 and/or the second filament stream 72, co-extruded in other suitable arrangements, or combinations thereof. The arrangement of the first filament stream 71, the second filament stream 72, and/or the third filament stream 73 with respect to one another can be formed by the arrangement and/or manipulation of the first pore 61, for example, rotating one or more pores, the second pore 62, and/or the third pore 63 within the thermal insulator 50. The third filament stream 73 may be a tri-component filament stream and may include a core layer (e.g., the filament stream 71), an annulus layer (e.g., the second filament stream 72), and an exterior layer (for example, the filament stream 73). The tri-component filament stream may be arranged and/or processed as the multi-component fiber 12.

The spinneret 20 can be configured to extrude two or more components identified for inclusion in a multi-component fiber. In one embodiment, the spinneret 20 can extrude a pharmaceutical composition having an active pharmaceutical ingredient. Such configurations may be especially beneficial for active pharmaceuticals that denature, are damaged, and/or are otherwise affected at relatively high temperatures. The extruded pharmaceutical composition can then be segmented in preparation for use (e.g., it may be sliced, expanded, and reshaped).

In one embodiment, the spinneret 20 can be configured to extrude a tri-component fiber for pharmaceutical applications. For example, the high-temperature component 23 can include one or more of the many known pharmaceutically-acceptable biodegradable protective substances (for example, synthetic and natural polyesters such as polylactides, polylactic acid and copolymers such as polycaprolactone, polyhydroxyalcanoates, polyalkene esters, and polyamide esters other than proteins; polyvinyl esters; vinyls such as polyvinyl alcohols, polyanhydrides; polyethers; polysaccharides such as cellulose, starch, hyaluronic acid; alginates; proteins; and/or degradable polyolefins). The insulating component 22 can include a pharmaceutically-acceptable material, such as any suitable resin with a higher melt-flow temperature than the material to be protected (otherwise, any suitable materials having a high degree of heterocyclic or aromatic character providing insulation such as proteins, saccharides, lipids, polyurethanes, polyamides, vinyls, and/or polyphenols).

The low-temperature component 21 can include active pharmaceutical ingredients, such as ABVD, AVICINE, Acetaminophen, Acridine carboxamide, Actinomycin, Alkylating antineoplastic agent, 17-N-Allylamino-17-demethoxygeldanamycin, Aminopterin, Amsacrine, Anthracycline, Antineoplastic, Antineoplaston, Antitumorigenic herbs, 5-Azacytidine, Azathioprine, BBR3464, BL22, Biosynthesis of doxorubicin, Biricodar, Bleomycin, Bortezomib, Bryostatin, Busulfan, Calyculin, Camptothecin, Capecitabine, Carboplatin, Chlorambucil, Cisplatin, Cladribine, Clofarabine, Cyclophosphamide, Cytarabine, Dacarbazine, Dasatinib, Daunorubicin, Decitabine, Dichloroacetic acid, Discodermolide, Docetaxel, Doxorubicin, Epirubicin, Epothilone, Estramustine, Etoposide, Exatecan, Exisulind, Ferruginol, Floxuridine, Fludarabine, Fluorouracil, 5-Fluorouricil, Fosfestrol, Fotemustine, Gemcitabine, Hydroxyurea, Idarubicin, Ifosfamide, Imiquimod, Irinotecan, Irofulven, Ixabepilone, Lapatinib, Lenalidomide, Liposomal daunorubicin, Lurtotecan, Mafosfamide, Masoprocol, Mechlorethamine, Melphalan, Mercaptopurine, Methotrexate, Mitomycin, Mitotane, Mitoxantrone, Nelarabine, Nilotinib, Nitrogen mustard, Oxaliplatin, PAC-1, Paclitaxel, Pawpaw, Pemetrexed, Pentostatin, Pipobroman, Pixantrone, Polyaspirin, Plicamycin, Procarbazine, Proteasome inhibitor, Raltitrexed, Rebeccamycin, SN-38, Salinosporamide A, Satraplatin, Stanford V, Streptozotocin, Swainsonine, Taxane, Tegafur-uracil, Temozolomide, ThioTEPA, Tioguanine, Topotecan, Trabectedin, Tretinoin, Tris(2-chloroethyl)amine, Troxacitabine, Uracil mustard, Valrubicin, Vinblastine, Vincristine, Vinorelbine, Vorinostat, Zosuquidar, and combinations thereof. The volume/area, arrangement, and/or amount of the components 21, 22, 23 can be selected in accordance with desired properties. For example, dosage and release profile of the active pharmaceutical ingredient can be controlled by volume/area, arrangement, and/or amount of the components 21, 22, 23.

The spinneret 20 can co-extrude active pharmaceutical ingredients with a carrier polymer having a minimum desired carrying temperature without destabilizing or otherwise damaging the integrity of the active pharmaceutical ingredient. Similarly, other organic-based products may be formed by the spinneret 20. For example, the spinneret 20 can be used to form engineered tissue, bio-molecules, osteoblasts in collagen, chemicals, anti-fungal products, two-phase lubricants (otherwise lubricants that can reach a certain temperature and then release an interior component), pesticides, photostabilizers, seed packs (with or without surrounding nutrients), agrochemicals, solar fibers, herbs, vitamins, diagnostic and/or tracking products (indicating whether a substance has been contaminated by bacteria and/or fungus, indicating whether a substance has been exposed to radiation and/or undesirable temperatures, and/or indicating the age of substances through controlled degradation of an interior or exterior component), and/or fluid systems having incompatible components being commingled for concurrent delivery.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A spinneret comprising:
a first substrate having a first pore configured for extruding a first component of a multi-component fiber;
a second substrate having a second pore configured for extruding a second component of the multi-component fiber; and
a thermal insulator positioned between the first pore and the second pore and configured for preventing heat from the first component from damaging the second component; and,
wherein the first component and the second component have incompatible thermal resistance.

2. The spinneret of claim 1, wherein the thermal insulator comprises:
a substrate including one or more cavities defined by the substrate;
wherein the substrate is between the first pore and the second pore;
wherein the one or more cavities are configured for receiving an insulating substance, and
wherein the insulating substance is configured for transferring heat from the one or more cavities.

3. The spinneret of claim 2, wherein the one or more cavities are configured to transfer a lesser amount of heat form the first pore, the first component being a high-temperature component, and configured to transfer a greater amount of heat from the second pore, the second component being a low-temperature component.

4. The spinneret of claim 3, wherein the amount of heat transferred from the second pore permits co-extrusion of the low-temperature component, the low-temperature component being susceptible to damage when the temperature reaches a range of about 41° C. to about 44° C.

5. The spinneret of claim 1, further comprising a third pore configured for extruding an insulating component between the first component and the second component.

6. The spinneret of claim 1, wherein the spinneret may be manipulated thereby affecting the arrangement of the first component and the second component.

7. The spinneret of claim 1, further comprising:
a first fluid channel configured to receive the first component and introduce the first component to the first pore; and
a second fluid channel configured to receive the second component and introduce the second component to the second pore.

8. A spinneret comprising:
a first pore configured for extruding a high-temperature component of a multi-component fiber;
a second pore configured for extruding a low-temperature component of the multi-component fiber; and
a thermal insulator positioned between the first pore and the second pore, the thermal insulator comprising:
a substrate including one or more cavities defined by the substrate;
wherein the one or more cavities is configured for receiving an insulating substance, and
wherein the thermal insulator is configured for transferring a lesser amount of heat from the first pore and a greater amount of heat from the second pore, thereby preventing heat from the high-temperature component from damaging the low-temperature component and for transferring heat from the one or more cavities; and,
wherein the high-temperature component and the low-temperature component have incompatible thermal resistance.

9. The spinneret of claim 8, wherein the amount of heat transferred from the second pore permits co-extrusion of the low-temperature component, the low-temperature component being susceptible to damage when the temperature reaches a range of about 41° C. to about 44° C.

10. The spinneret of claim 8, wherein the arrangement of the high-temperature component and the low-temperature component may be manipulated by manipulation of the spinneret.

11. The spinneret of claim 8, further comprising a third pore configured for extruding an insulating component between the first component and the second component.

12. A spinning process comprising:
providing a spinneret comprising:
a first pore configured for extruding a first component of a multi-component fiber,
a second pore configured for extruding a second component of the multi-component fiber, the second component having an incompatible thermal resistance with the first component; and
a thermal insulator positioned between the first pore and the second pore and configured for preventing heat from the first component from damaging the second component; and,
introducing the first component of the multi-component fiber to the spinneret;
introducing the second component of the multi-component fiber to the spinneret;
extruding the first component through the first pore of the spinneret;
extruding the second component through the second pore of the spinneret;
transferring heat from the first pore and the second pore, the first component being a high-temperature component and the second component being a low-temperature component, the amount of heat transferred from the first pore being lower than the amount of heat transferred from the second pore; and
forming the multi-component fiber.

13. The spinning process of claim 12, further comprising introducing an insulating component to a third pore in the thermal insulator.

14. The spinning process of claim 13, further comprising extruding the insulating component after extruding the low-temperature component but before extruding the high-temperature component.

15. The spinning process of claim 12, wherein the transferring of the greater amount of heat from the second pore is performed by an insulating substance disposed within one or more cavities formed in the spinneret.

16. The spinning process of claim 15, wherein the insulating substance flows through the one or more cavities.

17. The spinning process of claim 12, further comprising maintaining a temperature of the low-temperature component below a range of about 41° C. to about 44° C.

18. The spinning process of claim 12, further comprising manipulating the spinneret to manipulate the arrangement of the low-temperature component and the high-temperature component.

19. The spinning process of claim 18, wherein the arrangement of the low-temperature component and the high-temperature component is substantially coaxial.

20. The spinning process of claim 18, wherein the arrangement of the low-temperature component and the high-temperature component is intertwined.
